(19) United States
(12) Patent Application Publication
(10) Pub. No.: US 2024/0197087 A1
(43) Pub. Date: Jun. 20, 2024

(54) SECURITY DOOR SYSTEM TO PREVENT THEFT

(71) Applicant: TRINITY MANUFACTURING, LLC, Metuchen, NJ (US)

(72) Inventors: Eric Henry, Bound Brook, NJ (US); George Cox, Hamburg, PA (US)

(73) Assignee: TRINITY MANUFACTURING, LLC, Metuchen, NJ (US)

(21) Appl. No.: 18/539,568

(22) Filed: Dec. 14, 2023

Related U.S. Application Data
(60) Provisional application No. 63/432,396, filed on Dec. 14, 2022.
(60) Provisional application No. 63/526,817, filed on Jul. 14, 2023.

(51) Int. Cl. A47F 3/12; A47F 3/00; E05B 65/00; E06B 3/36

(52) U.S. Cl. CPC A47F 3/125; A47F 3/001; E05B 65/0025; E06B 3/365; E06B 1/12

(57) ABSTRACT

The present disclosure provides for a security door system for a retail store setting. The security door system, in general, provides for a locked case that is easier to install, lighter weight, and more robust than current security door products and is further made, in part, of an unbreakable clear polycarbonate. The present security door system thereby limits or prevents a thief from being able to steal a retail product protected by the security door system.

### CROSS-REFERENCE TO RELATED APPLICATIONS

This application claims priority to U.S. Application Ser. No. 63/432,396 filed on Dec. 14, 2022 and U.S. Application Ser. No. 63/526,817 filed on Jul. 14, 2023, the contents of both of which are herein fully incorporated by reference in its entireties.

### FIELD OF THE EMBODIMENTS

The field of the embodiments of the present invention relates to a security door system for retail stores providing a locked case that is easier to install than current security door products and is made of unbreakable clear polycarbonate plastic versus what is most commonly used today—tempered glass. In particular, the present invention and its embodiments allow for the use of polycarbonate for security doors resulting in virtually no chance of breakage while implementing design characteristics to limit the flex of the door thereby preventing a thief from getting his/her hand between the security doors to steal a retail good.

### BACKGROUND OF THE EMBODIMENTS

Many categories of products at retail, due to relatively high sales prices and consumer desirability, are more likely to be stolen and as a result, are currently locked up by the retailer or should be. These actual product categories commonly include but are not limited to fragrances, family planning items, infant formula, detergent and other cleaning products, beauty products, electronics, sporting goods, tools, etc.

Retailers and their employees remain frustrated at the current situation. Thieves are becoming more brazen and often retailers are powerless to stop them. Even time-honored techniques such as locked tempered glass case systems are falling out of vogue with retailers. Not only are these tempered glass case systems expensive and the dramatic increase in theft has increased the need for more such systems, especially in urban stores, but thieves have become more brazen in breaking traditional and expensive tempered glass solutions.

According to the National Retail Council, in 2022 around $112.1 billion worth of goods are stolen from retailers each year; this number is up from 2021's $93.9 billion. The Retail Industry Leaders Association moreover reported that 1 in 11 people will commit the crime of shoplifting at some point in their lives, but only 10 million people have been caught shoplifting in the last five years. This, in turn, means massive losses being shouldered by retailers due to theft. For example, according to Walmart, it loses some $6 billion-plus dollars every year from theft, or more than 1% of its $600+ billion in revenue. A less expensive and more secure theft deterrent system is thus needed.

The present invention and its embodiments aim to limit the ability of thieves to break into glass security doors as well as make more economically viable security door systems because of lower system costs as well as lower installation costs. In addition, the present invention and its embodiments also offer a variety of options due to the machinability of polycarbonate to shape and create openings to allow shoppers new ways to access products that tempered glass did not afford while restricting thieves from looting the retailer's products.

### SUMMARY OF THE EMBODIMENTS

In general, the embodiments of the present invention provide a security door system utilizing a polycarbonate-based security door. This allows the product of the present disclosure to overcome many, if not all, of the inherent problems with tempered glass security door systems that can be readily smashed and the product pilfered.

In one embodiment, the frame holding the polycarbonate doors is made of a metal, preferably, steel, and has a number of features to prevent the polycarbonate from flexing out of the channels. One such feature is a metal welded T-frame construction that is very robust, whereas another feature is the polycarbonate doors are pre-assembled for consistent execution, which also provides a lower “total cost” to the retailer. In some embodiments, there is a metal cross-bar that has the lock integrated into the crossbar to provide strength for the polycarbonate. Even further, the frame may have deeper side channels to prevent the polycarbonate doors from flexing too much, as well as middle door supports to disallow flex of the polycarbonate in both the top and bottom vertical halves. Finally, a bracket design around the lock-area in a middle of the frame system is intended to prevent thieves from leveraging the middle section of the display apart in order to break into the system.

When any pressure or force is applied to the embodiments of the present invention, at least the above features ensure that the door security system is virtually impenetrable to thieves trying to force open the doors. The additional benefit of using polycarbonate (preferably ¼″ thick) based doors is that each door only weighs about 13 lbs. as opposed to the 25 lbs. for traditional glass doors. The embodiments of the present invention also require less metal for the polycarbonate based door, thereby further reducing the weight of the doors.

Installation from a weight perspective is much easier and less expensive due to the aforementioned properties of the doors of the present system. Since this security door system can be preassembled, it can attach any number of ways to protect product merchandise. Glass doors cannot be pre-assembled; they would break in shipment. Hence, another additional benefit to the present polycarbonate door system is that requires less packaging to ship as well as less time to install, both those features help to lower the cost of a polycarbonate based door system of the present invention versus a traditional glass one. For installation, in a scenario of shelved product, simple brackets can attach the frame to the existing gondola base deck and top shelf, making for easy installation. Brackets can also be made to attach the door assembly to other gondola types.

In yet another embodiment, metal (preferably steel) glides may be attached to the doors and the top and bottom frames. The glides also serve as spacers that allow the doors to pass by each other in a smooth fashion. In yet another embodiment, as previously described, the polycarbonate based doors provide the option to shape the door or pierce it with holes or openings. This, in turn, allows for more options for shoppers/consumers being able to shop in a locked case without having to find a retail employee to unlock the door for them.

In one aspect of the present invention, there is a security device for preventing the theft of goods, the security device includes: a frame having a first end and a second end, a first door and a second door coupled to the frame, where the first door has a first panel and the second door has a second panel, and where the first panel and the second panel are formed from polycarbonate, a first locking mechanism configured to selectively lock a position of the first door and the second door, a horizontal crossbar spanning a distance between the first end of the frame and the second end of the frame, where the first locking mechanism is coupled to the horizontal crossbar, a vertical crossbar spanning a distance between a top of the frame and a bottom of the frame, and a plurality of mounting mechanisms configured to secure the frame to an existing structure.

The security device may also further include at least one end panel.

The security device may also further include at least one lighting element coupled to an interior surface of the frame.

The security device may also include where the plurality of mounting mechanisms are coupled to the frame via a plurality of apertures on a rear surface of the frame.

In another aspect of the present invention, there is a security device for preventing theft of goods, the security device includes: a frame having a first end and a second end, at least one adapter configured to couple to the frame, a first door, and a second door coupled to the frame, where the first door has a first panel and the second door has a second panel, and where the first panel and the second panel are formed from polycarbonate, a first locking mechanism configured to selectively lock a position of the first door and the second door, a horizontal crossbar spanning a distance between the first end of the frame and the second end of the frame, where the first locking mechanism is coupled to the horizontal crossbar, a vertical crossbar spanning a distance between a top of the frame and a bottom of the frame, at least one support coupled to the vertical crossbar, and a plurality of mounting mechanisms configured to secure the frame to an existing structure.

The security device may also include where there is at least one support coupled to the vertical crossbar above a position of the horizontal crossbar.

The security device may also include where there is at least one support coupled to the vertical crossbar below a position of the horizontal crossbar.

The security device may also include where the first panel and the second panel are about ¼″ thick.

The security device may also include where the first locking mechanism is a plunger lock.

The security device may also include where the first panel or the second panel has one or more apertures.

The security device may also include where at least one end panel has a teeth and groove fastener configured to couple to the frame.

The security device may also include where the first panel, second panel, or at least one end panel is transparent.

In yet another aspect of the present invention, there is a security device for preventing theft of goods, the security device includes: a frame having a top, a bottom, a first end, and a second end, where the frame has a t-frame configuration, at least one adapter configured to couple to the frame at either of the first end or the second end, a first door and a second door coupled to the frame, where the first door has a first panel and the second door has a second panel, and where the first panel and the second panel are formed from polycarbonate, a first locking mechanism configured to selectively lock a position of the first door and the second door, a horizontal crossbar spanning a distance between the first end of the frame and the second end of the frame, where the first locking mechanism is coupled to the horizontal crossbar, a vertical crossbar spanning a distance between a top of the frame and a bottom of the frame, at least one support coupled to the vertical crossbar, and a plurality of mounting mechanisms configured to secure the frame to an existing structure.

The security device may also include where a channel along the first end of the frame and the second end of the frame covers a portion of the first panel and the second panel respectively.

The security device may also include where at least one support is a lock bracket.

The security device may also include where one or more mounting tabs are located on the bottom of the frame along a length of the bottom the frame.

The security device may also include where at least one adapter is at least one shelf bracket.

The security device may also include where at least one adapter is at least one gondola insert.

The security device may also include where one or more mounting tabs are configured to couple to a thru-hole of a retail store base deck.

The security device may also include where at least one end panel is coupled to either of the first end of the frame or the second end of the frame.

Other technical features may be readily apparent to one skilled in the art from the following FIGURES, descriptions, and claims. In general, the present invention succeeds in conferring the following benefits and objectives.

It is an object of the present invention to provide a security door system formed in part from polycarbonate as opposed to tempered glass.

It is an object of the present invention to provide a security door system that is easier to install in a retail setting than traditional security door systems.

It is an object of the present invention to provide a security door system that provides an unfettered view of the retail product(s) located behind the security doors.

It is an object of the present invention to provide a security door system that can easily be locked and unlocked by a retail employee or other designated individual.

It is an object of the present invention to provide a security door system that is less expensive than many traditional security door systems.

It is an object of the present invention to provide a security door system that is less prone to breakage and theft than existing security door systems.

It is an object of the present invention to provide a security door system that has a pass through opening thereby allowing retail store patrons to access a limited amount of product without having to have the security doors unlocked.

It is an object of the present invention to provide a security door system that is lighter in weight than existing security door systems.

### BRIEF DESCRIPTION OF THE DRAWINGS

To easily identify the discussion of any particular element or act, the most significant digit or digits in a reference number refer to the FIGURE number in which that element is first introduced.

FIG. 1 illustrates an overview of a front of an embodiment of the present invention.

FIG. 2 illustrates the frame of an embodiment of the present invention featuring a minimalistic crossbar.

FIG. 3 illustrates a view from the back and side indicating how the frame is attached at the top of a retail gondola via brackets to a store's existing gondola and to the bottom gondola base deck via shelf perforations or thru-holes.

FIG. 4 illustrates the frame attached, alternatively, to a gondola shelf as well as the base deck.

FIG. 5 illustrates support brackets that are pre-assembled to the front and back doors.

FIG. 6 illustrates door assembly details including the crossbar, the notched finger holes for moving the doors, and the support brackets.

FIG. 7 illustrates details of the lock mechanism.

FIG. 8 illustrates an exemplary bracket around the lock mechanism.

FIG. 9 illustrates end panels being attached to the frame.

FIG. 10 illustrates a first rendering of an embodiment of the present invention in a retail environment.

FIG. 11 illustrates a second rendering of an embodiment of the present invention in a retail environment.

FIG. 12 illustrates a third rendering of an embodiment of the present invention in a retail environment.

### DETAILED DESCRIPTION OF THE DRAWINGS

The preferred embodiments of the present invention will now be described with reference to the drawings. Identical elements in the various FIGURES are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

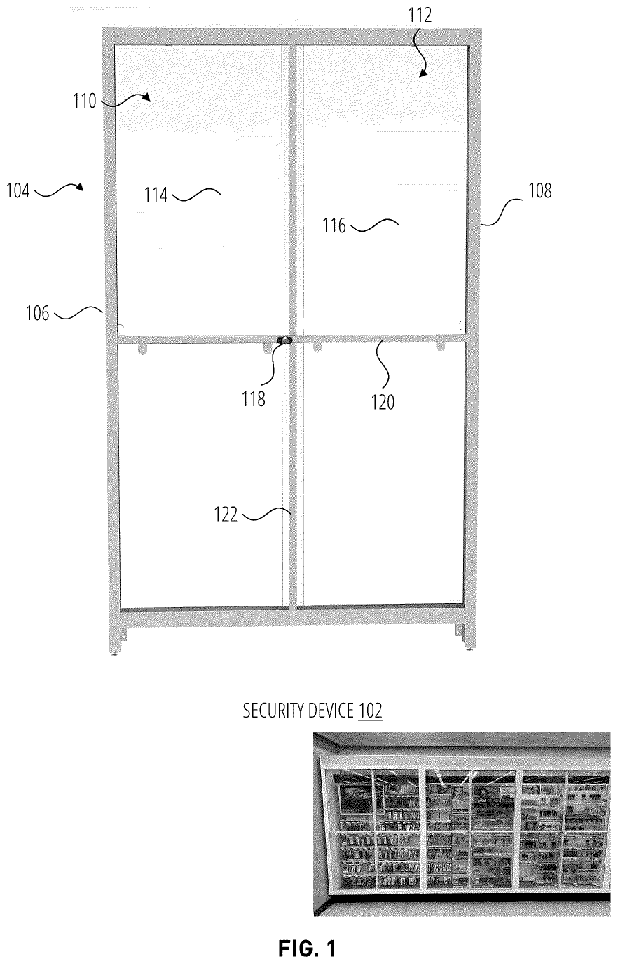

Referring now to FIG. 1 there is a front view of an embodiment of the present invention that may be retrofitted onto an existing retail display. The existing retail display may take the form of a case, shelving, or the like, or some combination thereof. Shown in FIG. 1 is a security device 102 for preventing theft of goods, the security device 102 having a frame 104 with a first end 106 and a second end 108. Further, there is a first door 110, and a second door 112 coupled to the frame 104. The first door 110 has a first panel 114 and the second door 112 has a second panel 116. In a preferred embodiment, each of the first panel 114 and the second panel 116 are formed from polycarbonate.

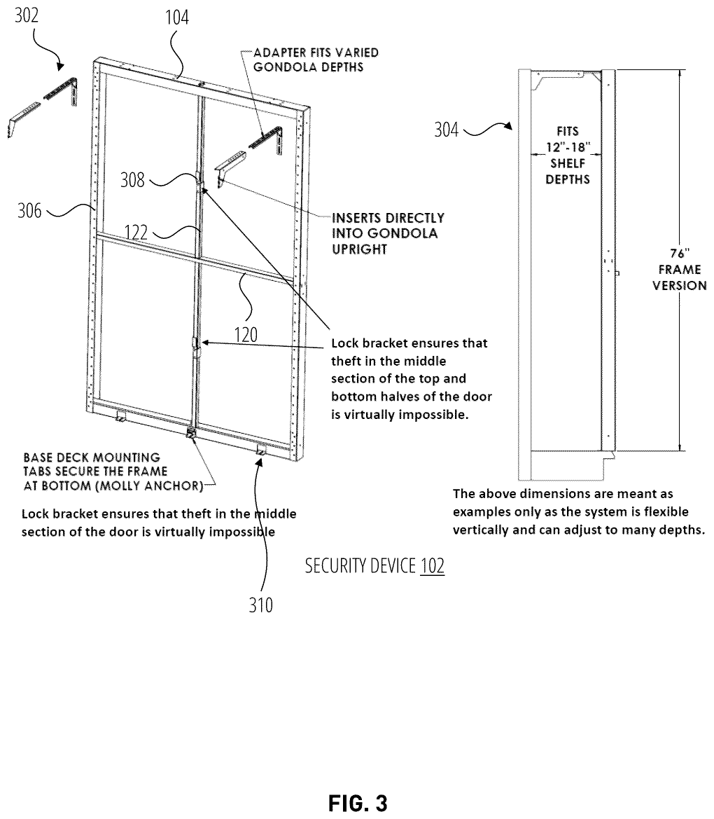

Separately, there may be a first locking mechanism 118 configured to selectively lock a position of the first door 110 and the second door 112. A horizontal crossbar 120 is configured to span a distance between the first end 106 of the frame 104 and the second end 108 of the frame 104. In at least one embodiment, the first locking mechanism 118 is coupled to the horizontal crossbar 120. A vertical crossbar 122 is configured to span a distance between a top of the frame 104 and a bottom of the frame 104. A plurality of mounting mechanisms 302 (see FIG. 3) are configured to secure the frame 104 to an existing retail store display.

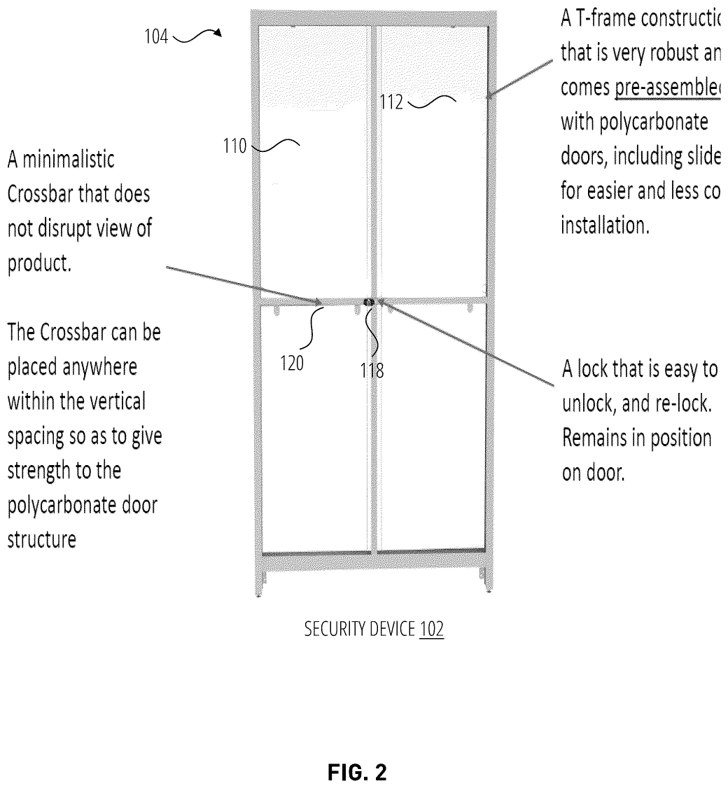

FIG. 2 demonstrates more details of the security device 102. The frame 104 is preferably of a T-frame configuration that is sufficiently robust for security purposes. In at least some embodiments, it is preferable that the doors come preassembled in the frame 104 for ease of installation and shipping as well as ensuring the components are assembled in the proper fashion to prevent theft of the retail goods. A T-frame configuration is a frame where the cross-section of the frame forms a letter “T” from an upstanding vertical component and a horizontal component resting thereupon.

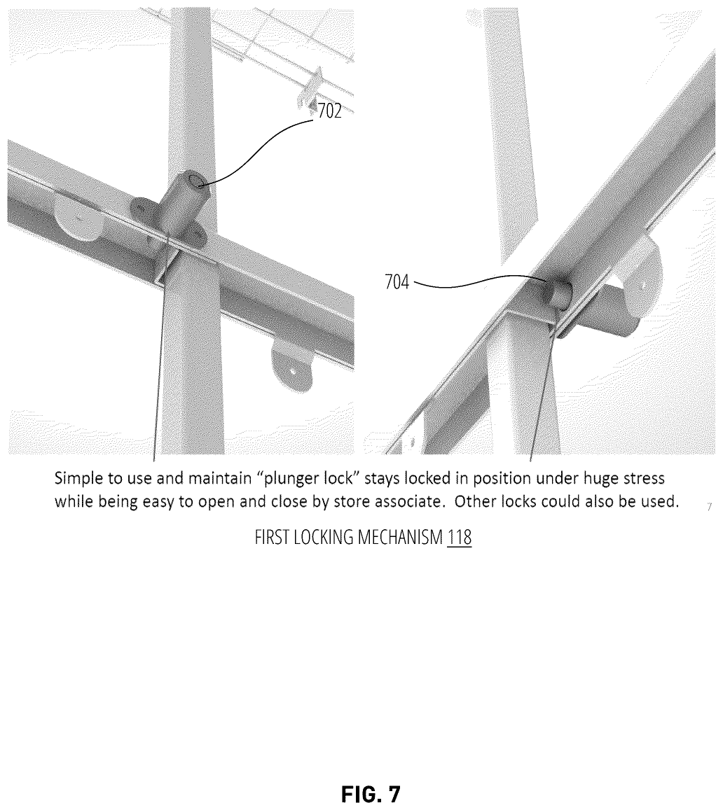

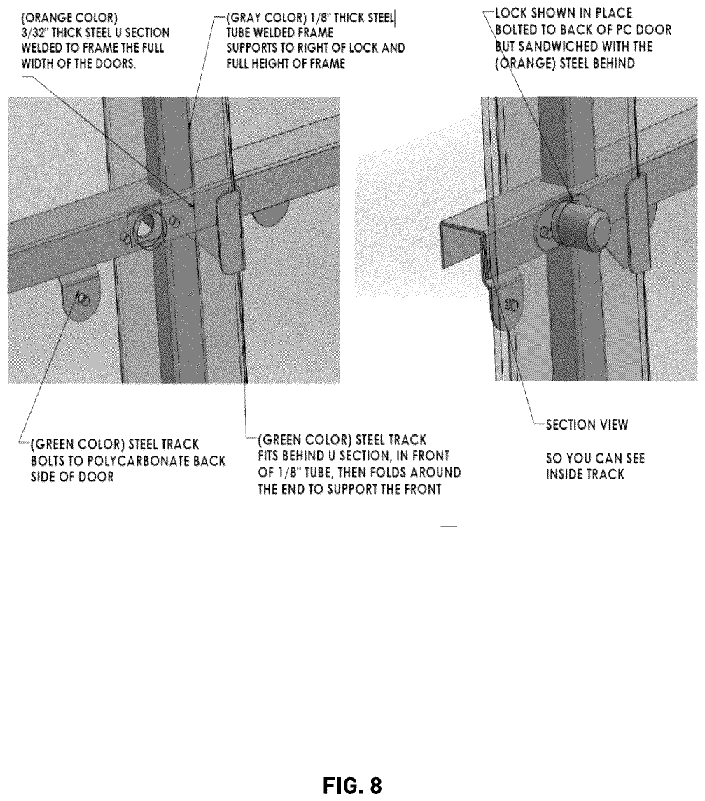

In addition to the frame 104, the horizontal crossbar 120 can be positioned at any point between the top of the frame 104 and the bottom of the frame 104. However, it is preferable that the horizontal crossbar 120 is positioned strategically to provide added strength to each of the first door 110 and the second door 112. It is further preferable to reduce a profile of the horizontal crossbar 120 such that the horizontal crossbar 120 does not disrupt a consumer's view of the retail product positioned behind the security device 102. The first locking mechanism 118, as further described in FIGS. 7-8, is configured to be readily locked and unlocked by a sales associate or other approved retail store entity thereby allowing access to the retail product located behind the security device 102.

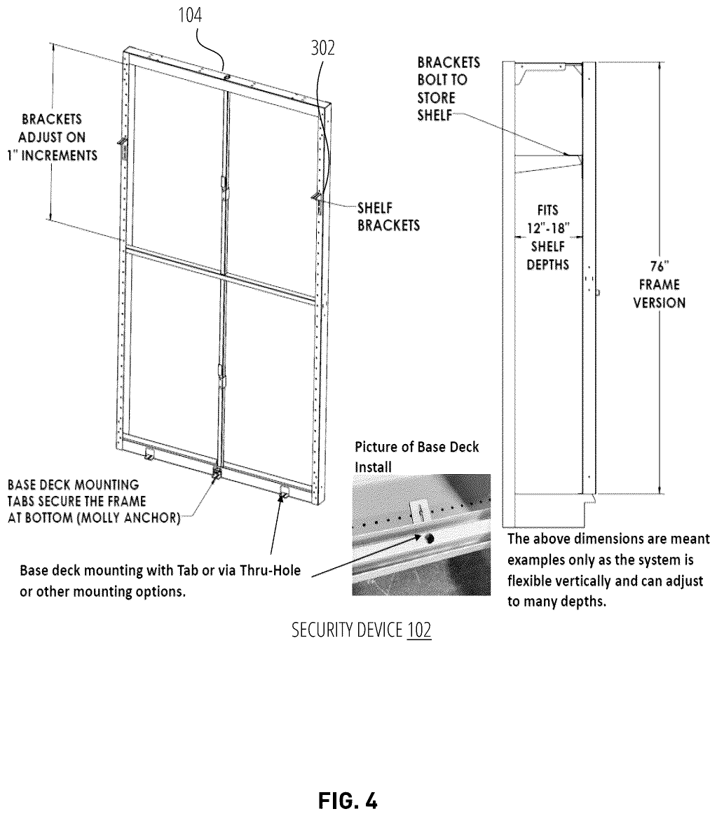

Turning now to FIG. 3 and FIG. 4, there is a rear view and corresponding side view of the frame 104 as well as demonstrating an attachment of the frame 104 to an existing retail store structure 304. In FIG. 3 the existing retail store structure 304 is a gondola whereas in FIG. 4 the existing retail store structure 304 is shelving. However, the principles of operation and the structure of the security device 102 remain largely the same as will be described below.

The rear of the frame 104 features a plurality of mounting mechanisms 302 which are configured to be inserted or engaged with the existing retail store structure 304 to thereby secure the frame 104 to the existing retail store structure 304. Along a height of the frame 104 there are a plurality of apertures 306 by which the plurality of mounting mechanisms 302 may be inserted into the frame 104 to secure said plurality of mounting mechanisms 302 to the frame 104.

In addition, these plurality of apertures 306 are strategically positioned and spaced such that the plurality of mounting mechanisms 302 may be placed at virtually any position along a height of the frame 104. This allows the plurality of mounting mechanisms 302 to be positioned at any position needed in order to adequately secure the frame 104 to the existing retail store structure 304. Not only can the plurality of mounting mechanisms 302 be spaced at any point along a length of a height of the frame 104, but are also sized and shaped to allow for various depth engagements. For example, the plurality of mounting mechanisms 302 have a protrusion which may engage the existing retail store structure 304 at multiple points along a length of the protrusion. This allows for greater flexibility in coupling the security device 102 to the existing retail store structure 304.

Further, there is at least one lock bracket 308 positioned on a rear of the vertical crossbar 122. The lock bracket 308 is configured to ensure that a potential thief cannot steal product from the security device 102. In at least one embodiment, there is one lock bracket 308 positioned above the horizontal crossbar 120 and one lock bracket 308 positioned below the horizontal crossbar 120. These lock brackets 308 when correctly positioned thereby limit movement of either of the first door or the second door such that theft of the retail product behind the security device 102 is virtually impossible.

The security device 102 further features at least one base deck mounting 310 in order to couple the frame 104 to the lower portion of the existing retail store structure 304. In at least one embodiment the base deck mounting 310 is a Molly anchor.

As shown in FIG. 4, the plurality of mounting mechanisms 302 are shelf brackets as opposed to the gondola inserts as described in FIG. 3. The operation of the security device 102 otherwise largely remains the same save for this point of connection. Here, the shelf brackets engage directly with the shelving (as opposed to the support structure) of the existing retail store structure 304. The shelf brackets are essentially L-shaped brackets that can be bolted (or other suitable means) to the frame 104 and the shelf of the existing retail store structure 304.

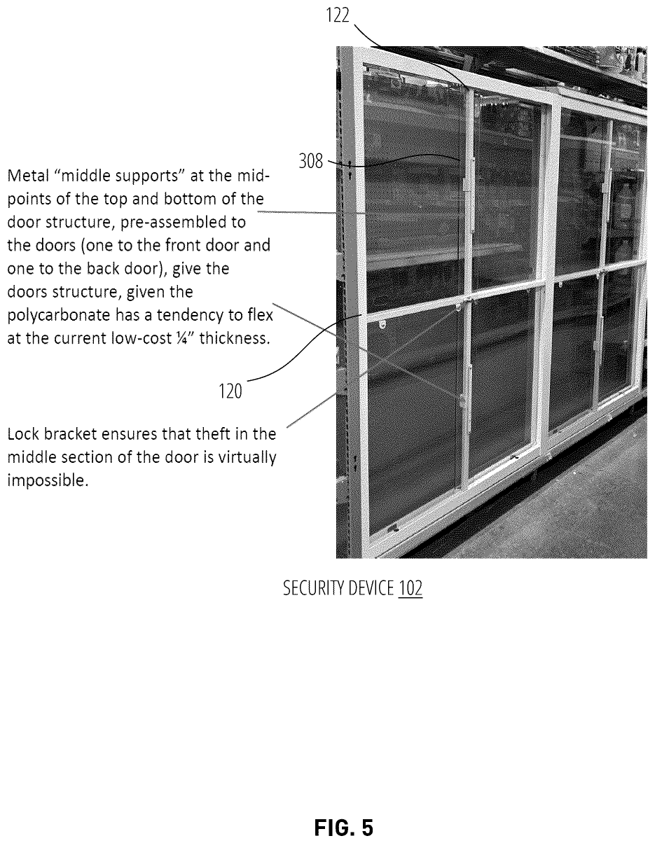

FIG. 5 demonstrates a further view of the lock bracket 308 that is located on either of the first door or the second door of the security device 102. The lock bracket 308 is preferably positioned at a midpoint of the respective door structure located above and below the horizontal crossbar 120. The criticality of the lock bracket 308 lies in shoring some structural aspects of the embodiments of the present invention. For example, in a preferred embodiment the first panel and the second panel are formed from ¼″ thick polycarbonate (for weight, cost, etc.). However, polycarbonate of such a thickness has a tendency to flex particularly given the size of the polycarbonate. Given that the purpose of the security device 102 is to prevent theft of objects stored or displayed behind the security device 102, flexing of the panels would enable theft and run contradictory to the tenets of the present invention. The lock bracket 308 is configured to prevent such flexing.

In at least one embodiment, the lock bracket 308 is secured, via mechanical or other suitable means, to the vertical crossbar 122. It is preferable that there is one lock bracket 308 secured to the vertical crossbar 122 above the location of the horizontal crossbar 120 and one lock bracket 308 secured to the vertical crossbar 122 below the location of the horizontal crossbar 120. However, there may be other lock brackets 308 utilized in the execution of the present invention. Further, it is preferable that the lock bracket 308 is located at a midpoint between a top of the frame and the location of the horizontal crossbar 120 and a midpoint between a bottom of the frame and the location of the horizontal crossbar 120. This midpoint location provides the most rigidity and structure to the doors. The lock brackets 308, depending on the size, structure, and position, serve to limit or prevent either the door or panel from flexing.

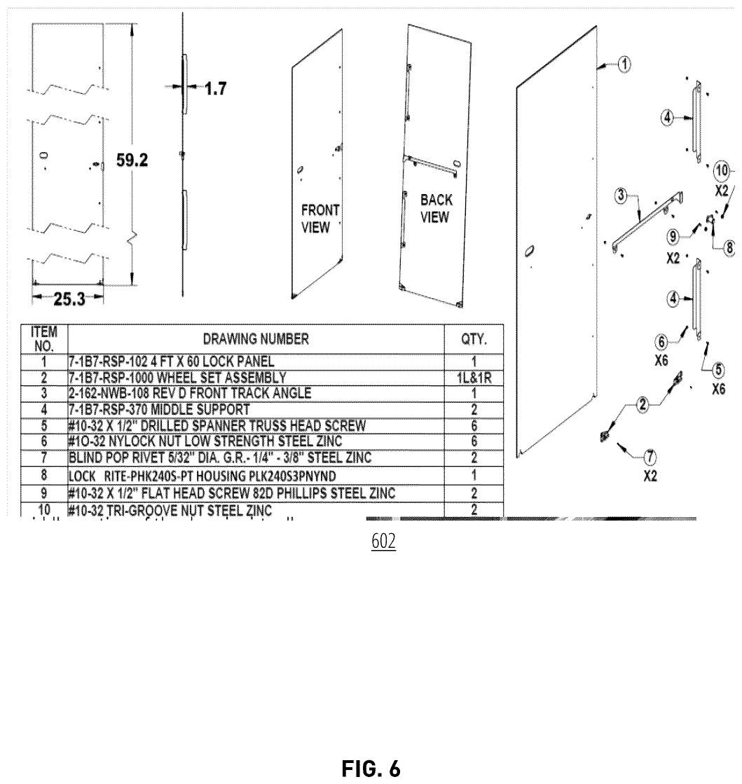

FIG. 6 demonstrates an exploded view of a first door or second door consistent with an embodiment of the present invention.

FIGS. 7-8 illustrate a preferred first locking mechanism 118 of an embodiment of the present invention. As shown in FIG. 7, the first locking mechanism 118 is preferably a plunger lock style mechanism. Such a first locking mechanism 118 may have at least a key hole 702 and a spring loaded cylinder 704. By virtue of operation a key may interact with the key hole 702 to cause the spring loaded cylinder 704 to either protrude from a rear of the first locking mechanism 118 thereby preventing the sliding of the doors of the present invention as shown in FIG. 7. Further interactions with the key hole 702, by an appropriate key, would cause the spring loaded cylinder 704 to retract into a body of the first locking mechanism 118 thereby allowing the doors of the present invention to readily slide and allow access to the retail product stored/displayed behind.

FIG. 8 shows the structure of an embodiment of the bracket that interacts with and/or surrounds the first locking mechanism. As shown, the bracket has a first end and a second end. The first end of the bracket is preferably bolted or otherwise secured to a rear surface of either the first panel or the second panel of the first door or the second door, respectively. This leaves this portion of the bracket inaccessible to a consumer, etc. when the doors are engaged and secured.

From the end secured to the panel (either first or second) a body portion of the bracket passes through and/or behind the horizontal crossbar. The bracket may have, as shown in FIG. 8, an aperture to allow the locking mechanism to pass therethrough. This allows the locking mechanism to interact with the bracket and further secure the doors as desired.

The second end of the bracket is bent or folded around towards the front surface of the first panel and/or second panel. As shown the second end, rather than being bolted or otherwise secured as with the first end, is positioned to prevent movement from one door across another door. That is, it prevents the door closest (in a slightly staggered configuration) to the user from being slid open. The bracket further serves, due to its configuration and structure, the prevent one from attempting to access product behind the door(s) when the doors are locked by the locking mechanism. The bracket will prevent “flexing” or bending of the door which could otherwise be a possibility with the door/panel structure of the present invention.

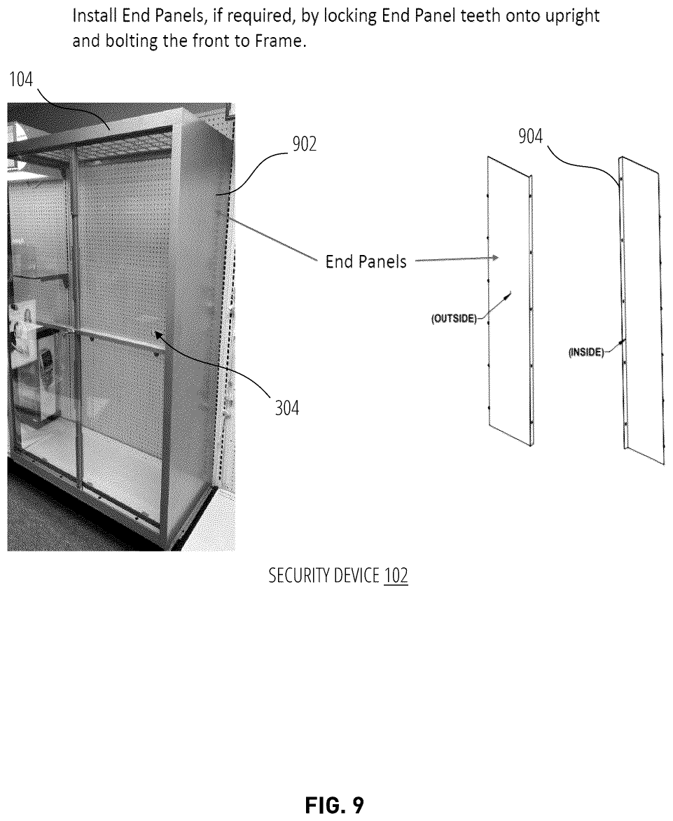

As shown in FIG. 9, there are one or more end panels 902 which are configured to attach to a frame 104 of the security device 102. While previously described was the frame 104 as a whole, along with the door, panel, and locking structures, there further needs to be, in most instances, at least one end panel 902 that prevents someone from simply reaching around an edge of the frame 104 to access the products stored/displayed behind.

The end panels 902 are generally flat pieces of metal configured to be secured to the frame 104 to prevent one from accessing the product stored behind the security device 102. In order to allow for proper securing of the end panels 902, there are teeth 904 which are configured to engage openings in the existing retail store structure 304. These teeth 904 are located on an interior surface of the end panel 902 (once end panel 902 is properly positioned) and engage with openings in the existing retail store structure 304. In other strategic locations, the end panel 902 may be further bolted to the frame 104 thereby readily securing the end panel 902 to the frame 104. This creates a sealed enclosure by which the retail product can be displayed without concern for theft of the retail product.

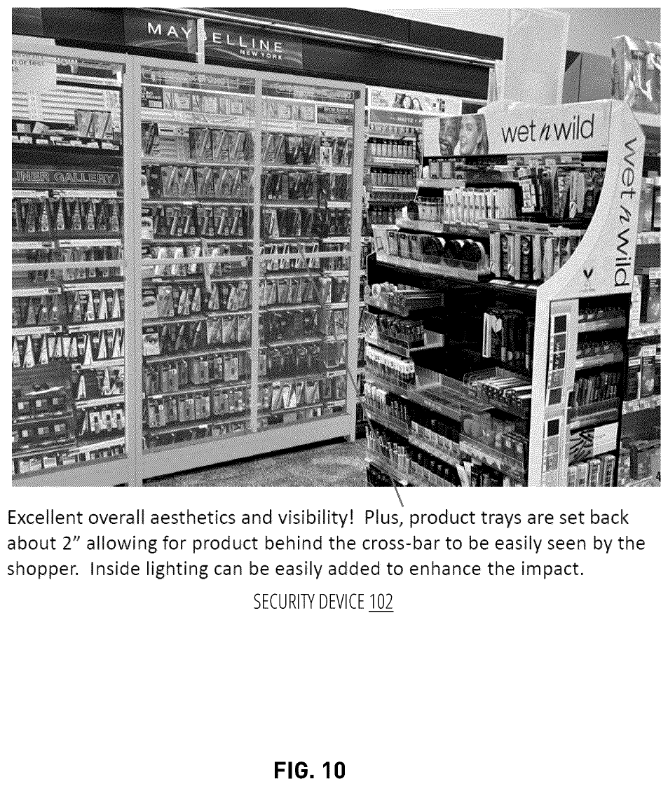

In FIGS. 10-12, there are illustrations depicting three different potential embodiments of the security device 102. FIG. 10 illustrates a high-profile retail store solution. This particular implementation allows for heightened overall aesthetics and visibility of the retail product for the consumer. Preferably, the product trays/shelves are set back about two inches from the doors of the security device 102 which helps to prevent theft through any portion of the security device 102 as well as makes the product behind the horizontal crossbar and vertical crossbar readily visible to the consumer.

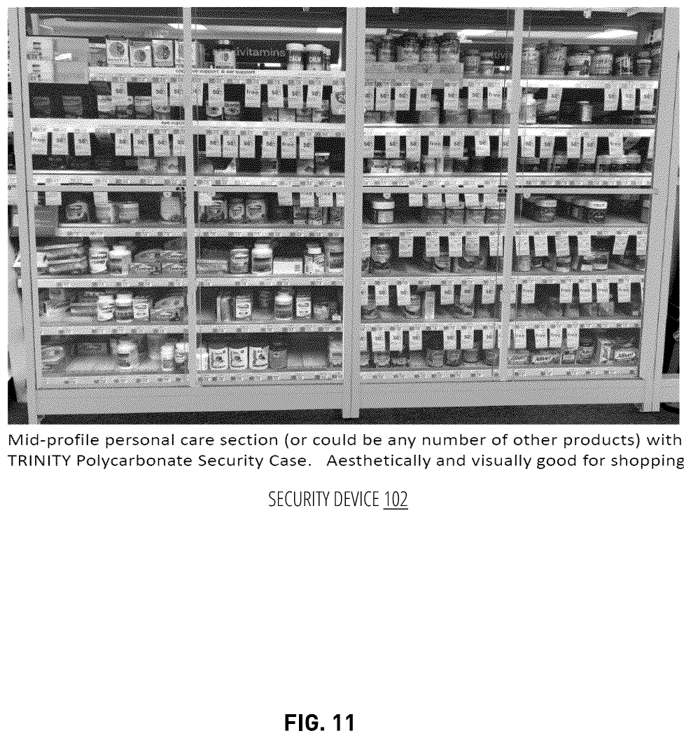

FIG. 11 illustrates a mid-profile retail solution housing a plethora of personal care products. However, the nature of the goods may vary with the implementation of the security device 102. This particular security device 102 while having a lower profile of the security device 102 shown in FIG. 10 enjoys all of the same structural benefits to product visibility and access while preventing thefts from the retail environment.

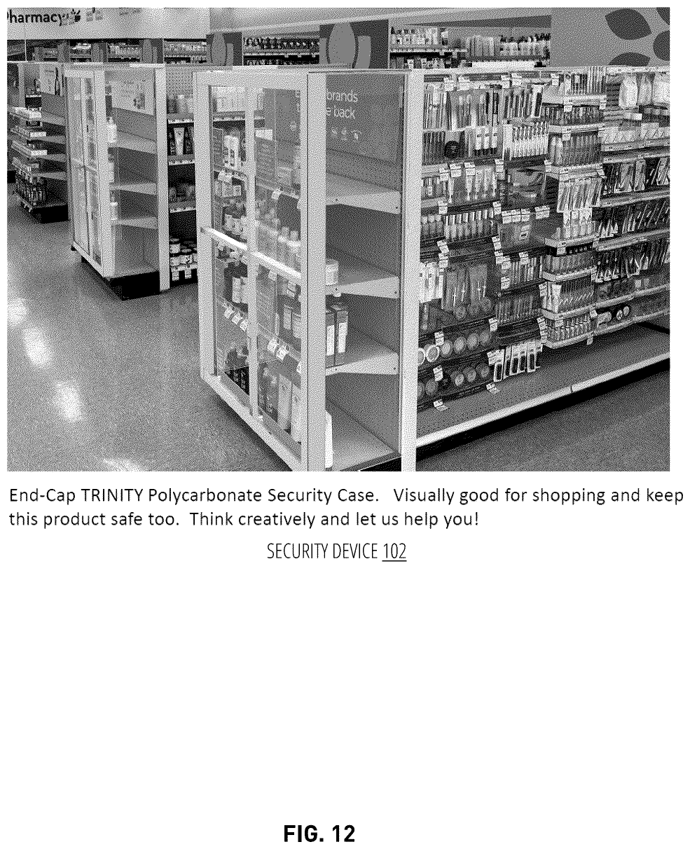

FIG. 12 illustrates a slightly different embodiment than that of FIG. 10 and FIG. 11. Here, the security device 102 is positioned on an end cap. This allows for protection of end cap designated products (as opposed to larger tray or shelf displays) while permitting for high product visibility in the high traffic areas where end caps are located. Of particular note, is the additional inclusion of the end panels. The end panels, as previously described, utilize much of the same structure and materials as the doors, but are not intended to open but rather protect the retail product positioned behind the security device whilst allowing clear visibility of the retail product to the consumer. The foregoing embodiments shown in FIGS. 10-12 are included here for illustrative purposes only to highlight exemplary implementations of the security device 102 detailed herein. There are, however, any number and embodiments of actual implementations of the security device 102 described herein that may be assembled based on the needs of any given retail store.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A security device for limiting access to goods, the security device comprising:
a frame having a first end and a second end;
a first door and a second door coupled to the frame,
wherein the first door has a first panel and the second door has a second panel, and
wherein the first panel and the second panel are formed from polycarbonate;
a first locking mechanism configured to selectively lock a position of the first door and the second door;
a horizontal crossbar spanning a distance between the first end of the frame and the second end of the frame,
wherein the first locking mechanism is coupled to the horizontal crossbar;
a vertical crossbar spanning a distance between a top of the frame and a bottom of the frame; and
a plurality of mounting mechanisms configured to secure the frame to an existing structure.

2. The security device of claim 1 further comprising at least one end panel.

3. The security device of claim 2 where the at least one end panel is coupled to either the first end of the frame or the second end of the frame.

4. The security device of claim 1 further comprising at least one lighting element coupled to an interior surface of the frame.

5. The security device of claim 1 wherein the plurality of mounting mechanisms are coupled to the frame via a plurality of apertures on a rear surface of the frame.

6. A security device for limiting access to goods, the security device comprising:
a frame having a first end and a second end;
at least one adapter configured to couple to the frame;
a first door and a second door coupled to the frame,
wherein the first door has a first panel and the second door has a second panel, and
wherein the first panel and the second panel are formed from polycarbonate;
a first locking mechanism configured to selectively lock a position of the first door and the second door;
a horizontal crossbar spanning a distance between the first end of the frame and the second end of the frame,
wherein the first locking mechanism is coupled to the horizontal crossbar;
a vertical crossbar spanning a distance between a top of the frame and a bottom of the frame;
at least one support coupled to the vertical crossbar; and
a plurality of mounting mechanisms configured to secure the frame to an existing structure.

7. The security device of claim 6 wherein there is at least one support coupled to the vertical crossbar above a position of the horizontal crossbar.

8. The security device of claim 6 wherein there is at least one support coupled to the vertical crossbar below a position of the horizontal crossbar.

9. The security device of claim 6 wherein the first panel and the second panel are about ¼″ thick.

10. The security device of claim 6 wherein the first locking mechanism is a plunger lock.

11. The security device of claim 6 wherein the first panel or the second panel has one or more apertures.

12. The security device of claim 6 wherein the at least one end panel has a teeth and groove fastener configured to couple to the frame.

13. The security device of claim 6 wherein the first panel, second panel, or at least one end panel are transparent.

14. A security device for limiting access to goods, the security device comprising:
a frame having a top, a bottom, a first end, and a second end,
wherein the frame has a t-frame configuration;
at least one adapter configured to couple to the frame at either of the first end or the second end;
a first door and a second door coupled to the frame,
wherein the first door has a first panel and the second door has a second panel, and
wherein the first panel and the second panel are formed from polycarbonate;
a first locking mechanism configured to selectively lock a position of the first door and the second door;
a horizontal crossbar spanning a distance between the first end of the frame and the second end of the frame,
wherein the first locking mechanism is coupled to the horizontal crossbar;
a vertical crossbar spanning a distance between a top of the frame and a bottom of the frame;
at least one support coupled to the vertical crossbar; and
a plurality of mounting mechanisms configured to secure the frame to an existing structure.

15. The security device of claim 14 wherein a channel along the first end of the frame and the second end of the frame covers a portion of the first panel and the second panel respectively.

16. The security device of claim 14 wherein the at least one support is a lock bracket.

17. The security device of claim 14 wherein one or more mounting tabs are located on the bottom of the frame along a length of the bottom the frame.

18. The security device of claim 14 wherein the at least one adapter is at least one shelf bracket.

19. The security device of claim 14 wherein the at least one adapter is at least one gondola insert.

20. The security device of claim 14 wherein the one or more mounting tabs are configured to couple to a thru-hole of a retail store base deck.
